(19) United States
(12) Patent Application Publication
(10) Pub. No.: US 2017/0233266 A1
(43) Pub. Date: Aug. 17, 2017

(54) Method and Device for Treating Water by Electrolysis

(71) Applicant: Eotec SARL, Bessieres (FR)

(72) Inventor: Morou Boukari, Toulouse (FR)

(21) Appl. No.: 15/428,957

(22) Filed: Feb. 9, 2017

Related U.S. Application Data
(60) Provisional application No. 62/295,957, filed on Feb. 16, 2016.

(30) Foreign Application Priority Data
Feb. 12, 2016 (FR) 1651150

(51) Int. Cl. C02F 1/467; C02F 1/461

(52) U.S. Cl. CPC C02F 1/467; C02F 1/46109; C02F 2103/42

(57) ABSTRACT

The invention relates to a method for treating water by electrolysis, comprising the following operations:
producing two electrolytic dipoles (D1 and D2),
connecting each of the dipoles (D1 and D2) to a source of electrical energy, and remarkable in that it further comprises the following operations:
arranging the two dipoles inside the same enclosure (330) wherein the water to be treated circulates,
inverting one of the dipoles so as to position facing the water flow to be treated the cathode of the second dipole extending from the anode of the first dipole and the anode of the second dipole extending from the cathode of the first dipole,
moving the two dipoles (D1, D2) closer together to a sufficiently reduced distance to create therebetween electrical and chemical interactions and thereby form an at least quadripolar electrolysis system,
channeling the gases resulting from the electrolysis implemented via a first dipole (D1) to the second dipole (D2).

The invention also relates to a device for implementing the method.

Applications: water treatment.

### FIELD OF APPLICATION OF THE INVENTION

The present invention relates to the field of water treatment and particularly to adaptations enabling the use of electrolysis for producing oxidizing and disinfectant substances under optimum conditions.

### DESCRIPTION OF THE PRIOR ART

It is known to use the electrolysis technique for producing chemical oxidation and disinfection substances for water treatment and particularly for treating the water of pleasure pools.

The electrolysis performed is conventionally that referred to as the chloralkali process intended to produce by means of electrical energy, dihydrogen (H₂), sodium hydroxide (NaOH) and dichlorine (Cl₂) from water (H₂O) charged with salt (NaCl).

On dissolving in water, the salt produces Cl⁻ and Na⁻ ions.

The oxidation at the anode (connected to the +pole of the generator) can be represented as follows:

2H₂O (liquid)→O₂ (gas)+4H⁺ (aqueous)+4e⁻

The reduction at the cathode (connected to the −pole of the generator) can be represented as follows:

4H₂O (liquid)→2H₂ (gas)+4OH⁻ (aqueous)

The half-reactions taking place with the ions obtained from the dissolution of the salt are:

At the anode: 2Cl⁻→Cl₂+2e⁻

At the cathode: Na⁺+H₂O+e⁻→NaOH+1/2 H2

The half-reactions should be isolated from one another so as not to perform electrolysis of the water. This isolation may be performed by a membrane confining the chloride ions in the anodic bath.

More generally, this gives:

2Na⁺+2Cl⁻+2H₂O→2NaOH +Cl₂ +H₂

By reacting dichlorine with water, a hypochlorous acid (HOCl) is also obtained according to the following reaction: Cl₂+H₂O→HOCl+HCl.

As such, a powerful oxidizing, antibacterial, antialgal disinfectant is obtained.

Nevertheless, such a conventional method for producing dichlorine from water charged with salt involves a number of drawbacks:

As described above, the production of dichlorine (Cl2) is always accompanied by the production of caustic soda (sodium hydroxide NaOH) which gives rise to an increase in the potential of hydrogen (pH) which requires an intervention in order to restore equilibrium. Given that these two parameters are linked, the same applies with the alkalinity level;

In the treatment of water of pleasure pools, so that all the water of the pool can be treated, the salt is dissolved in the entire volume of water which requires a large quantity of salt. The presence of salt (NaCl) at a very high dose in the pool (1 to 5 g/l grams per liter) may cause drying of users' skin. Furthermore, in order to ensure the concentration thereof, salt needs to be added regularly, which requires monitoring and regular intervention.

A further known water treatment technique consists of introducing into water, hydrogen peroxide (H₂O₂) which is a powerful oxidant and disinfectant. Nevertheless, this product has the drawback of having a reduced period of effective activity requiring regular interventions. Furthermore, it requires increasingly complex storage and distribution conditions representing an impediment to the full commercial development thereof.

The prior art does not offer a genuine alternative to the drawbacks cited above.

As such, for example, the document U.S. Pat. No. 5,997,717 describes an apparatus and a method wherein two separate electrolysis cells suitable for producing a peroxide but in small quantities are arranged in succession.

The document US 2003/0070940 for its part describes a method and an apparatus for water purification wherein at least two identical electrolysis cells arranged in series simply adding the results of each cell to increase the output but neutralizing a portion of the results are arranged in succession.

The prior art also discloses in the document WO03/035556 that the partitioning or separation between the electrolysis cells even inside the same enclosure is the standard.

### DESCRIPTION OF THE INVENTION

Having observed the above, the applicant conducted research aimed at enhancing water treatment by electrolysis for producing oxidizing and disinfectant substances without the drawbacks of the prior art.

This research resulted in the design and implementation of a particularly original method for treating water by electrolysis suitable for countering the drawbacks of the prior art.

According to the invention, this method for treating water by electrolysis comprises the following operations:

producing two electrolytic dipoles each consisting of an anode and a cathode,

connecting each of the dipoles to a source of electrical energy with a given intensity and voltage for each dipole.

This method is remarkable in that it further comprises the following operations:

arranging the two dipoles inside the same enclosure wherein the water to be treated circulates,

inverting one of the dipoles so as to position facing the water flow to be treated the cathode of the second dipole extending from the anode of the first dipole and the anode of the second dipole extending from the cathode of the first dipole,

moving the two dipoles closer together to a sufficiently reduced distance to create therebetween electrical and chemical interactions and thereby form an at least quadripolar electrolysis system,

channeling the gases resulting from the electrolysis implemented via a first dipole to the second dipole.

Such a method is particularly advantageous in that it makes it possible to produce in water oxidizing and/or disinfectant substances without additional base substances. Indeed, according to one feature of the method, the method makes use of the specific elements dissolved in the water to convert same into oxidizing and disinfectant products and particularly hydrogen peroxide.

The various reactions leading to these technical effects are described hereinafter.

As conventionally,

the anode of the first dipole produces the following reaction:

2H₂O (liquid)→O₂ (gas)+4H⁺ (aqueous)+4e⁻

and,

the cathode of the first dipole will produce the following reaction:

4H₂O (liquid)+4e⁻→2H₂(gas)+4OH⁻(aqueous).

Furthermore, as conventionally and as for the preceding dipole, the anode of the second dipole produces the following reaction:

2H₂O(liquid)→O₂(gas)+4H⁺(aqueous)+4e⁻

and,

the cathode of the second dipole will produce the following reaction:

4H₂O(liquid)+4e⁻→2H₂(gas)+4OH⁻(aqueous).

The invention is situated in the interaction between the two dipoles implemented by gas channeling.

Indeed, the anode of the second dipole will also produce the following reaction:

H₂(gas from the cathode of the first dipole)→2H⁺+2e⁻

But above all the following synthesis

H₂ (gas obtained from the cathode of the first dipole)+O₂ (gas present on the anode of the second dipole)→H₂O₂

As such, the interaction between the dipoles and the gas channeling ensure the production of an oxidizing and disinfectant product, i.e. hydrogen peroxide (H₂O₂).

It is as such no longer necessary to store this peroxide or carry out the dosage thereof by adding in water, it is produced on demand by the method according to the invention. Furthermore, this method produces hydrogen peroxide without needing to amend the water with a reagent and/or with an electrolyte.

The method according to the invention involves a further advantage in that it provides a solution for water basification.

Indeed, a further reaction takes place at the anode of the second dipole, i.e.:

OH⁻+H→H₂O

The OH⁻ ions responsible for basification are thus neutralized by the H⁺ ions. As such, the substances produced by the method according to the invention do not give rise to water basification.

The cathode of the second dipole also becomes the site of hydrogen peroxide production and neutralization, by means of the following reactions:

Synthesis of O₂(gas obtained from the anode of the first dipole)+H₂(gas produced by the cathode of the second dipole)→H₂O₂

Hydrogen peroxide (H₂O₂) is thus also produced.

Cathodic reduction also takes place on the cathode of the second dipole and gives rise to the following reaction:

O₂(gas obtained from the anode of the first dipole)→O²⁻(superoxide ion)

This superoxide ion dismutates with the hydrogen ions H⁺ present in the solution to also produce hydrogen peroxide according to the following reaction:

O²⁻+2H⁺→H₂O₂

Moreover, as for the anode, the OH⁻ ions produced by the cathode of the second dipole are neutralized according to the following reaction:

OH⁻+H⁺→H₂O

As such, the cathode of the second dipole is also the site of hydrogen peroxide production without water basification.

It thus seems that the method according to the invention consists of producing a large quantity of hydrogen peroxide while keeping the water at equilibrium.

Furthermore, it seems that these reactions can be produced without adding reagents and/or electrolytes merely by choosing the materials of the dipoles according to known ranges.

Furthermore, by multiplying the number of reactions, the output is greater than that offered by the prior art.

Nevertheless, in order to increase outputs or favor one reaction over another, reagents and/or electrolytes may be used.

To the results of conventional electrolyses are added the results from the interaction of the substances produced, these results from the interaction being considerably superior to those obtained merely by adding the results of each dipole taken separately. It thus seems that the contribution of the invention is not situated in the mere juxtaposition of the two dipoles but above all in the use by the second dipole of the substances resulting from the first dipole and of the substances obtained from the combined electric field.

The method is all the more effective as the channeling of the gases is facilitated by the inversion. Not only does such an inversion facilitate the channeling of the gases but it also shortens the path taken by the ions. By facilitating the processing of the gases and the ions, the method according to the invention makes it possible to achieve a very satisfactory output.

According to a further particularly advantageous feature of the invention, the method comprises the following operation:

channeling the gases resulting from the electrolysis implemented by a first dipole to the second dipole by directing the gases from the anode of the first dipole toward the cathode of the second dipole and the gases from the cathode of the first dipole toward the anode of the second dipole.

A further advantage of the method according to the invention lies in that it consists of carrying out the production of dichlorine (Cl₂) and hypochlorous acid (HOCl) without the drawbacks of the prior art in respect of basification.

Indeed, as chloride ions Cl⁻ may already be present in the water, the following reactions occur:

At the anode of the first dipole 2C1⁻→Cl₂+2e⁻

At the anode of the second dipole 2C1⁻→Cl₂+2e^{-and}

H₂→2H⁺+2e⁻

At the cathode of the second dipole Cl₂(produced by A1)+H₂(produced by C2)→HCl

As explained above, the OH⁻ ions are neutralized.

As such, the method according to the invention can produce dichlorine without the drawbacks of the prior art.

Obviously, these reactions resulting in chlorine production see the output thereof increased in the case of salt addition.

A further advantage emerges from the method according to the invention which enables implementation equally well for the production of peroxide (H₂O₂) as for the production of dichlorine (Cl₂). As such, a single device may be devised and marketed for both productions and may be operated according to the legislation and treatments sought. The method is thus not exclusively dedicated to the production of peroxide.

A further advantage of the method according to the invention lies in the control of the energy required for the sought reactions. Indeed, the coupling, the electrical interaction of the dipoles demonstrate that the dipoles benefit from the production of electrons and consume less energy than adding the energies required for two dipoles which would not be in electrical interaction. The method goes further in that, according to a further particularly advantageous feature, it comprises the following operation:

channeling the gases resulting from the electrolysis implemented by a first dipole to the second dipole for the purposes of energy production, i.e. of electrons which are consumed in the other reactions. Indeed, the reactions described above produce electrons which will be advantageously used for this purpose.

As described above, the reactions resulting in the decomposition of hydrogen gas (H₂) produce electrons. These electrons will contribute to the electrical energy supply of the dipoles which will hence consume less electricity. As such, the method according to the invention implements reactions producing electrical energy self-consumed directly by the other energy-consuming reactions.

The method according to the invention thus not only offers a higher yield in the production of treatment substances but also a lower consumption.

Further features help increase the output of the proposed method.

As such, according to a further particularly advantageous feature of the invention, in order to promote the following synthesis reaction:

H₂(gas obtained from the cathode of the first dipole)+O₂(gas present on the anode of the second dipole)→H₂O₂ which enables the production of the disinfectant oxidant, at least one operation is selected from the following list:

increasing the exchange contact surface area at one or a plurality of electrodes,

locking the current intensity for the second dipole,

selecting a catalyst material for the anode of the second dipole.

Increasing the exchange surface area of the electrode facilitates exchange and thus increases the output.

Locking corresponds to a state of equilibrium between the energy produced which, if it is not extracted, goes in the reverse direction of the energy consumed. Locking thus corresponds to the sum of the two energies and results in equilibrium.

On equilibrating, the excess intensity is not consumed.

As explained above, it can be extracted from the system and a system with a low energy consumption can thereby be obtained.

This locking of the intensity therefore helps control the flow of electrons produced at the anode of the second dipole.

The choice of a catalyst material for the electrode (such as palladium Pd) will increase the output.

According to a further particularly advantageous feature of the invention, the method is remarkable in that it further comprises the following operation:

producing carbon dioxide (CO₂).

The supply of carbon dioxide (CO₂) in the method offers numerous advantages, among these:

dissolved in water, it produces carbonic acid;

it prevents the decomposition of hydrogen peroxide (H₂O₂) by dihydrogen H₂;

it dilutes the mixture O₂+H₂ and thus prevents an excessively explosive concentration.

In order to obtain carbon, according to a further particularly advantageous feature of the invention, an operation consists of producing an anode made of carbon or of graphite for the first dipole.

According to a further particularly advantageous feature, the method is remarkable in that it comprises the operation of injecting an electrolyte based on bicarbonate into the water to be treated.

According to a further particularly advantageous feature of the invention, the method is remarkable in that it comprises an operation for producing persulfate. The presence of persulfate is particularly advantageous for the oxidant properties thereof.

As such, the anode producing dioxygen (O₂) of the first dipole produces the following oxidation reaction:

2SO₄²⁻→S₂O₈²⁻(peroxodisulfate)

Peroxodisulfate has the advantage of being less sensitive to temperature variations making it possible to propose the complementary oxidant properties thereof to those of peroxide in the case of non-ideal temperature ranges for hydrogen peroxide.

Furthermore, the hydrolysis of persulfate results in the following reaction:

S₂O₈²⁻→H₂O₂+2HSO₄⁻

also producing hydrogen peroxide (H₂O₂).

According to a further particularly advantageous feature of the invention, the method is remarkable in that it comprises the operation for producing persulfate from the sulfate ions naturally present in the water to be treated.

According to a further particularly advantageous feature of the invention, the method is remarkable in that it comprises the operation for producing persulfate from the sulfate ions present in an electrolyte injected into the water to be treated according to the following reaction:

2SO₄²⁻→S₂O₈+4e⁻

According to a further particularly advantageous feature of the invention, the method is remarkable in that it comprises the following operation:

applying a different voltage according to the dipoles so as to promote interactions between the electrodes of different dipoles so as to create new dipoles between anodes and/or cathodes. This feature helps increase the oxidant production output of the method according to the invention.

According to a further particularly advantageous feature of the invention, the method is remarkable in that it comprises the following operation:

Arranging a porous lining downstream from the second dipole so as to promote the synthesis of hydrogen peroxide. This porous lining increases the substrate surface area required for the synthesis of hydrogen peroxide and helps increase the production output of said peroxide.

According to a further particularly advantageous feature of the invention, the method is remarkable in that it comprises the following operation:

circulating one or a plurality of electrolytes in the enclosure.

According to the material of the electrodes and according to the oxidizing and disinfectant treatment sought, one or a plurality of electrolytes may be used. As such, although the method according to the invention can be used with water not subject to an injection of reagent or electrolyte, the presence thereof may be preferred to prevent the natural variations in concentrations of the substances required for producing the oxidizing and disinfectant substances.

According to a further particularly advantageous feature of the invention, the method is remarkable in that it comprises the following operation:

varying the flow rate in order to establish the correct residence time of the electrolyte in the enclosure.

According to a further particularly advantageous feature of the invention, the connections of each dipole are independent. It is thereby possible to define different voltages and suitable for the electrolysis and the interactions that it is sought to promote. The voltages may also be equal.

According to a further particularly advantageous feature of the invention, the connections of each dipole are connected to a common power supply source.

The invention also relates to the device for implementing all or some of the features of the method described above.

The invention also relates to a device for implementing all or part of the method described above.

This device for treating water by electrolysis is remarkable in that it comprises an enclosure equipped with an inlet and an outlet of the water to be treated, said enclosure receiving at least four electrodes:

two anodes and two cathodes

with a single membrane creating a separation between the anodes and the cathodes, said membrane creating a conduit directing the displacement of the gases produced by a first dipole toward a second dipole while allowing ion migration.

The presence of this membrane channeling the production of the first electrolytic dipole in order to direct same toward the second electrolytic dipole ensures a satisfactory output.

According to a further particularly advantageous feature of the invention, a first dipole is arranged below the second dipole. This arrangement makes it possible to benefit from the displacement of the gases produced in the water by the first dipole and which will rise toward the second dipole.

According to a further particularly advantageous feature of the invention, said membrane forms a tube separating:

the anode from the cathode of a first dipole with the anode arranged in the hollow core of the tube and,

the anode from the cathode of the second dipole with the cathode arranged in the hollow core of the tube.

The presence of this membrane channeling the production of the first electrolytic dipole in order to direct same toward the second dipole which is inverted with respect to the first ensures a satisfactory output from the electrolyses proposed by the secondary dipoles.

In order to envisage the discharge of the gases trapped in the membrane but not dissolved, the device further comprises a trapped gas exhaust orifice.

In order to increase the peroxide production by increasing the possible contact surface areas promoting synthesis, the enclosure of the device comprises, according to a further particularly advantageous feature of the invention, a porous lining positioned downstream from the second dipole.

According to a further particularly advantageous feature of the invention, the device comprises a pump for regulating the water flow rate in the enclosure thereby making it possible to control this parameter.

According to a further particularly advantageous feature of the invention, the device comprises an electrolyte and/or reagent tank and an injection module arranged upstream from the enclosure and communicating with the inlet of the enclosure. It is then not necessary to treat all the water in the pool but merely the water entering the enclosure. The electrolyte and/or the reagent are then injected in the right quantity at the right time.

According to a further particularly advantageous feature, the material of the anode of the first dipole is selected from the following list:

stainless steel,

titanium,

platinum,

graphite, or

any catalytic materials.

The same applies for the anode of the second dipole.

According to a further particularly advantageous feature, the material of the cathode of the first dipole is selected from the following list:

stainless steel,

titanium,

platinum,

graphite, or

any catalytic materials.

The same applies for the cathode of the first dipole.

According to a preferred embodiment, the set of electrodes is made of titanium coated with a catalyst.

The electrodes (anodes or cathodes) may be of any forms, i.e. flat, cylindrical, helical, membranous, porous, granular.

Nevertheless, according to a further particularly advantageous feature of the invention, the anode and the cathode arranged in the hollow core of the tubular membrane are one-piece rectilinear rods whereas the anode and the cathode arranged outside the membrane are windings. Such a geometry makes it possible to adapt the electrodes to the tubular configuration of the membrane.

Furthermore, according to a further particularly advantageous feature, the enclosure in turn adopts the form of a vertical tube.

According to a further particularly advantageous feature, the four electrodes forming a pair of dipoles are rigidly connected to the same cap to form an interchangeable independent module secured to the enclosure by closing the orifices provided for this purpose, said enclosure comprising a plurality of orifices suitable for optionally each receiving a module. This feature makes it possible for the same enclosure to provide a different treatment output by adapting to the volume of water to be treated by increasing or decreasing the number of modules.

The fundamental concepts of the invention having been described above in the more elementary form thereof, further details and features will emerge more clearly on reading the following description with reference to the appended drawings, giving by way of non-limiting example, an embodiment of a device for treating water according to the invention.

### BRIEF DESCRIPTION OF THE FIGURES

FIG. 1 is a schematic drawing of the operating principle of a water treatment device according to the invention;

FIG. 2 is a schematic drawing of an embodiment of a device for treating water according to the invention;

FIG. 3 is a schematic drawing of a first embodiment of the electrolysis module;

FIG. 4 is a schematic drawing of a second embodiment of the electrolysis module.

### DESCRIPTION OF PREFERRED EMBODIMENTS

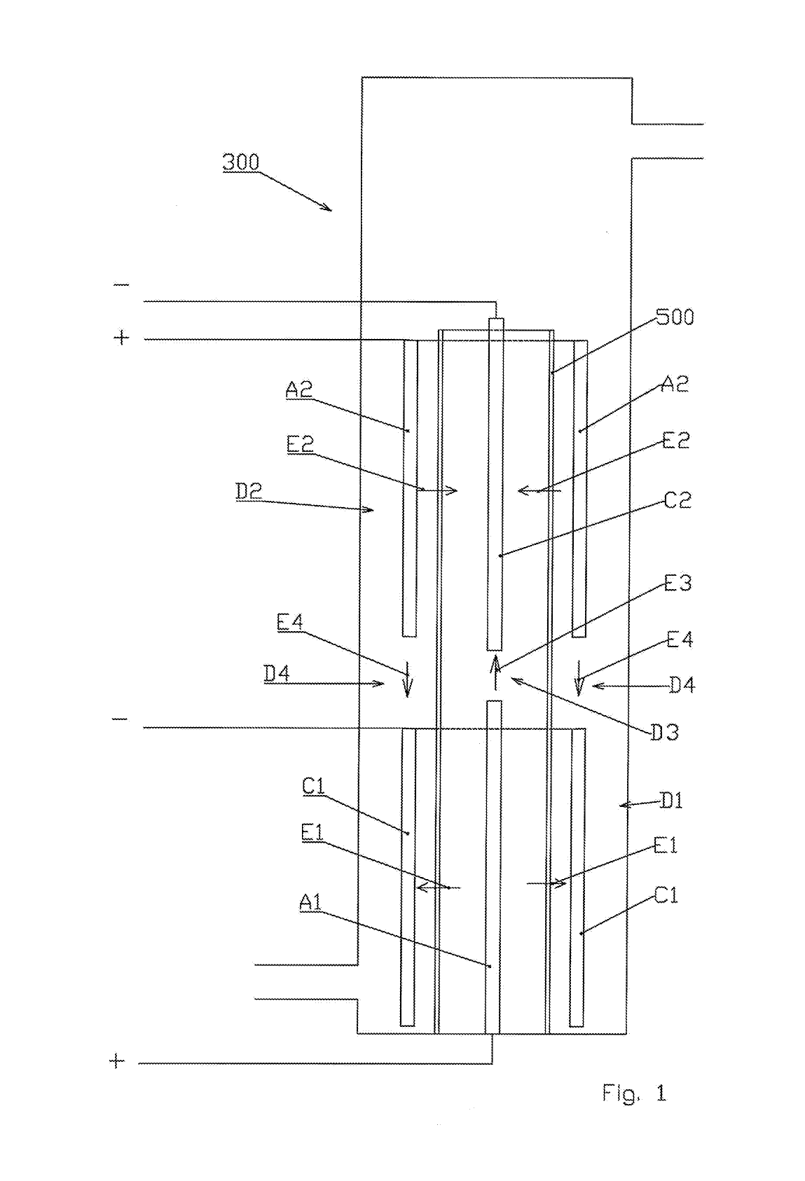

As illustrated in the principle diagram in FIG. 1, the method proposes to produce two electrolytic dipoles D1 and D2 each comprising a cathode C1, C2 and an anode A1 and A2.

Consequently, a first dipole D1 provides an interaction, i.e. an electrolysis E1 between A1 and C1 and the second dipole D2 provides an interaction, i.e. an electrolysis E2 between A2 and C2. In this case, two dipoles arranged in the same enclosure 300 are involved.

On moving same closer together, the electric fields overlap and interactions are created to form an at least quadripolar electrolysis system by creating electrical and chemical interactions, i.e. additional electrolyses E3 and E4 therebetween. Indeed, by moving the two base dipoles D1 and D2 described above closer together, the following additional dipoles are created:

D3 which provides an interaction i.e. an electrolysis E3 between A1 and C2,

D4 which provides an interaction i.e. an electrolysis E4 between A2 and C1.

Four electrolyses can thus be obtained.

The voltages applied respectively to the dipoles D1 and D2 are different herein.

The method according to the invention can be expressed as an equation as follows:

y=a1D1+a2D2+a12 D1D2

The production coefficient a12 is largely greater than a1 or a2.

This interaction is sought as the electrical interaction coefficient between the two dipoles enables a much greater production and cannot be compared to the mere addition of the results of two dipoles placed in series as proposed by the prior art.

Indeed, the electrical and chemical interaction obtained by moving closer together makes it possible to implement as explained above at least the following additional reactions:

H₂(gas from the cathode C1 of the first dipole D1)→2H⁻+2e⁻

But above all the following synthesis

H₂(gas from the cathode C1 of the first dipole D1)+O₂(gas present on the anode A2 of the second dipole D2) →H₂O₂

The applicant established that if the production coefficient of an electrolysis is considered to be equal to 1, the output of the two electrolyses without interactions is equivalent to 2 whereas the output of the two electrolyses to which the output of the other chemical reactions is added is equivalent to 12.

The dipoles are voluntarily represented as separated for better comprehension. According to a preferred embodiment, the two dipoles are separated by merely two millimeters.

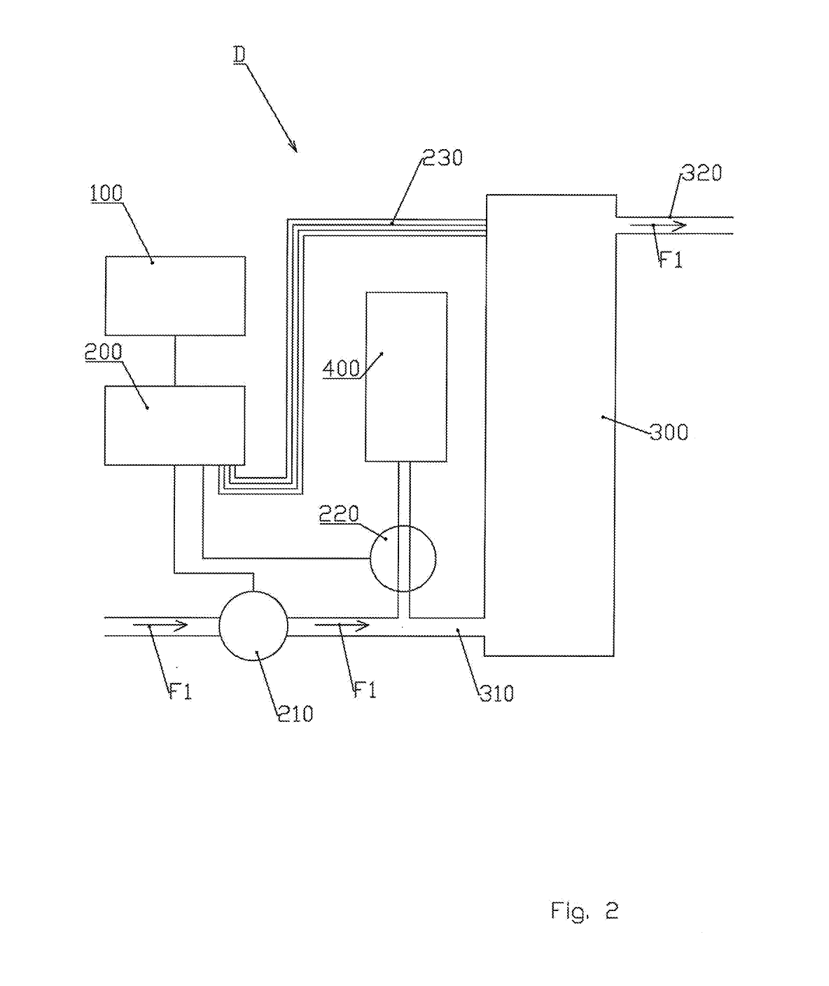

As illustrated in the drawing in FIG. 2, the device referenced D as a whole performs the water treatment for example of a pleasure pool not illustrated. It may be used alone or in association with further treatment and/or filtration devices.

This device D comprises an electrical power supply module 100 powering an electrical control, regulation and power supply module 200. This control module 200 controls the operation of an electrolysis module 300.

This electrolysis module 300 comprises an inlet conduit 310 of the water to be treated and an outlet conduit 320 of the treated water. The displacement of the water is illustrated by the arrow F1.

In order to control, regulate and power the electrolysis module 300, the control module 200 performs the control of a feed pump 210 providing the regular supply with water to be treated of the electrolysis module 300. It also performs the control of an injection module 220 upstream from the electrolysis module 300 of an electrolyte and/or reagent stored in a storage tank 400. This tank 400 may be implemented by a module for receiving interchangeable cartridges (not illustrated).

Finally, the control module 200 provides the electrical power supply via the wiring symbolized by the line referenced 230 of the electrodes of the electrolysis module 300 according to the intensity and voltage sought.

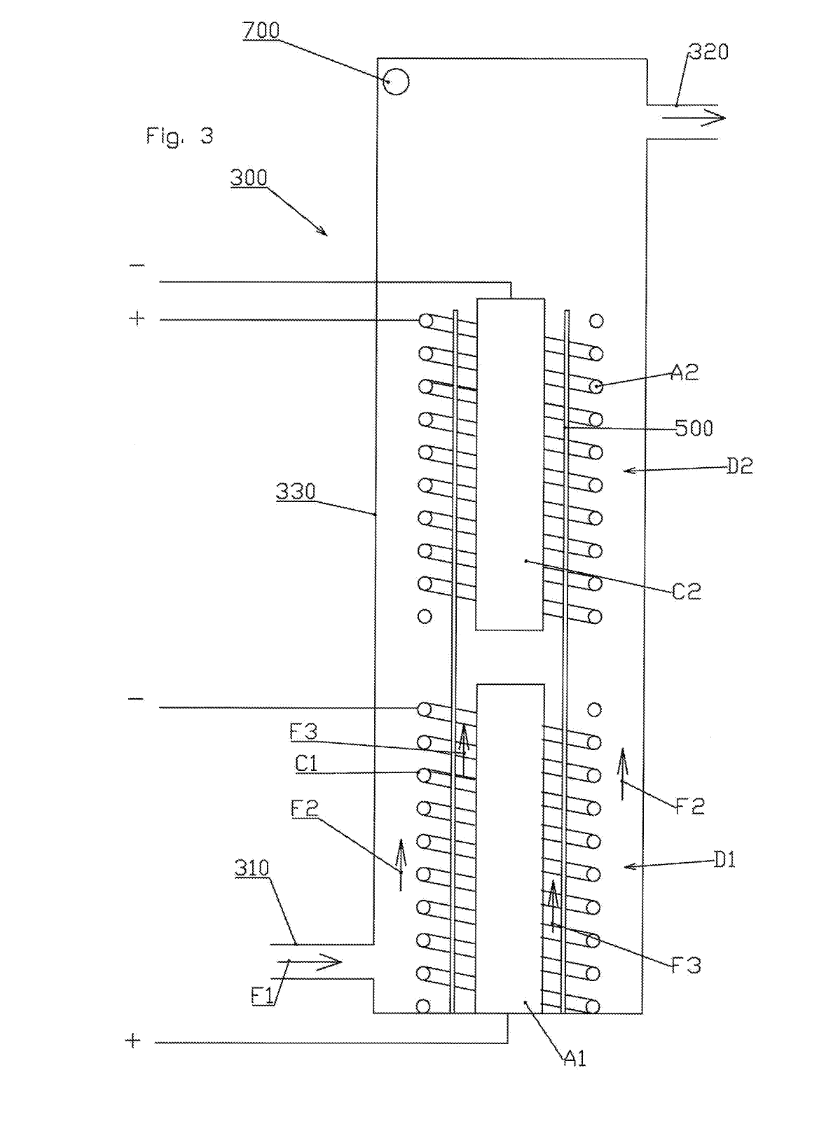

As illustrated in the drawing in FIG. 3, the electrolysis module 300 comprises four electrodes in the same enclosure 330 forming a vertical column:

two anodes A1, A2 (connected to a +pole) and two cathodes C1, C2 (connected to a−pole) distributed into two electrolytic dipoles D1 and D2 arranged in said enclosure 330 one on top of the other. The two electrolytic dipoles D1 and D2 are arranged one on top of the other and at a distance such that the electrical fields overlap from one dipole to the other. As such, the gases produced in the column will rise and the ions will be attracted by the electrodes of opposite polarity.

The electrolysis module 300 further comprises a single tubular membrane 500 creating a separation between the anodes A1, A2 and the cathodes C1, C2, said membrane 500 creating a conduit directing the displacement of the gases produced by a first dipole D1 toward the second dipole D2 while allowing ion migration. More specifically, said single tubular membrane 500 separates:

the anode A1 from the cathode C1 of the dipole D1 positioned at the lower part of the lower enclosure 330 with the anode A1 arranged in the hollow core of the tube 500 and the cathode C1 forming a winding positioned on the axis of the tube 500 positioned outside and at a distance from the external surface thereof, and

the anode A2 from the cathode C2 of the second electrolytic dipole D2 arranged above the first D1 with the cathode C2 arranged in the hollow core of the tube 500 and the anode A2 forming a winding positioned on the axis of the tube 500 positioned outside and at a distance from the external surface thereof.

As such, according to the invention, the dihydrogen H₂ obtained from the cathode C1 of the first dipole D1 is directed (arrows F2) toward the anode A2 of the second dipole D2 to produce the following reaction:

H₂→2H⁺+2e⁻.

This direction is carried out by channeling the dihydrogen gas H₂ between the internal wall of the enclosure 330 and the external wall of the membrane 500.

The zone around and above the anode A2 will above all be the site of the following synthesis:

H₂(channeled and obtained from the cathode C1 of the first dipole 500)+O₂(gas present on the anode A2 of the second dipole 600)→H₂O₂.

Furthermore, the freely circulating OH− and H+ ions engage at the anode A2 of the second dipole D2 according to the following reaction:

OH⁻+H⁺→H₂O.

The cathode C2 of the second dipole D2 receives the dioxygen O₂ channeled and obtained (arrows F3) from the anode A1 of the first dipole D1 which engages with the dihydrogen H₂ produced by the cathode C2 of the second dipole D2 to form hydrogen peroxide (H₂O₂) according to the following reaction:

H₂+O₂→H₂O₂ .

The channeling is then performed by the hollow core of the tubular membrane 500.

Hydrogen peroxide (H₂O₂) is thus also produced.

A cathodic reduction also occurs on the cathode C2 of the second dipole D2 with the dihydrogen O₂ channeled and obtained (arrows F3) from the anode A1 of the first dipole D1 to create superoxide ions (O²⁻).

This superoxide ion (O²⁻) dismutates with the hydrogen ions H⁺ not channeled and present in the solution to also produce hydrogen peroxide (H₂O₂) according to the following reaction:

O²⁻+2H⁺→H₂O₂

Moreover, as for the anode A2, the OH− ions produced by the cathode C2 of the second dipole 600 are neutralized according to the following reaction:

OH⁻+H→H₂O

It thus seems that the invention makes it possible to produce a large quantity of hydrogen peroxide while keeping the water at equilibrium.

According to one embodiment, the choice of materials is as follows:

the anode A1 of the first dipole D1 is made of graphite which makes it possible to produce carbon dioxide from the bottom of the electrolysis cell so that the entire volume of water of the enclosure 330 benefits therefrom with the advantages described above,

the cathode C1 of the first dipole D1 is made of copper,

the anode A2 of the second dipole D2 is made of steel,

the cathode C2 of the second dipole D2 is made of graphite,

the membrane 500 is porous and made of polypropylene.

It seems that the implementation of the method according to the invention can be performed with inexpensive materials rendering the large-scale marketing of the device viable.

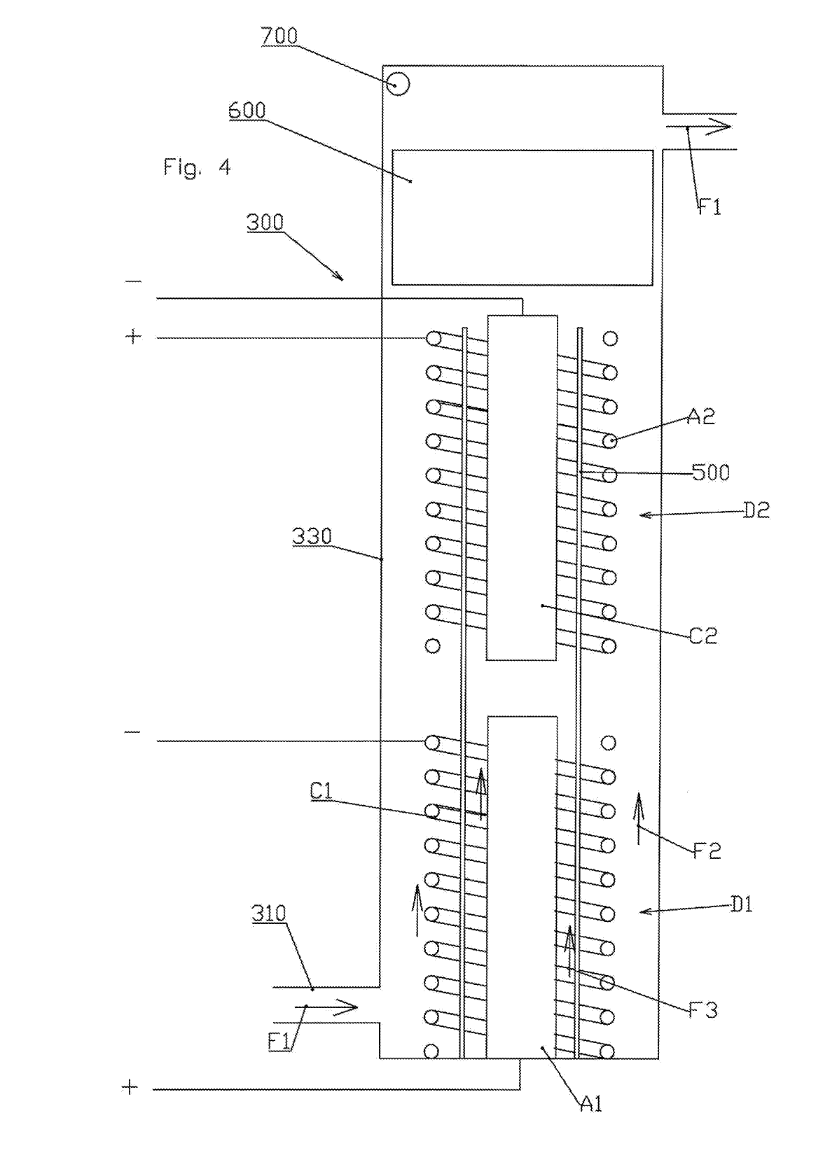

The embodiment illustrated by the drawing in FIG. 4 differs from the previous one by the additional presence of a porous lining 600 situated in the enclosure 330 downstream from the electrolytic dipoles D1 and D2, i.e. at the upper end of the vertical enclosure 330.

This porous lining serves as an additional substrate for further production of H₂O₂ by direct reaction between O₂ and H₂.

Furthermore, whether in the embodiment illustrated by the drawing in FIG. 3 or that illustrated by the drawing in FIG. 4, a gas outlet orifice 700 is provided in the enclosure 330. Obviously, this exhaust may be carried out directly through the water of an open-air pool.

It is understood that the method and the device have been described above and represented with a view to disclosure rather than limitation. Obviously, various adjustments, modifications and enhancements may be made to the example above, without leaving the scope of the invention.

1. Method for treating water by electrolysis, comprising the following operations:
producing two electrolytic dipoles (D1 and D2) each consisting of an anode (A1, A2) and a cathode (C1, C2),
connecting each of the dipoles (D1 and D2) to a source of electrical energy with a given intensity and voltage for each dipole (D1, D2),
characterized in that it further comprises the following operations:
arranging the two dipoles inside the same enclosure (330) wherein the water to be treated circulates,
inverting one of the dipoles so as to position facing the water flow to be treated the cathode of the second dipole extending from the anode of the first dipole and the anode of the second dipole extending from the cathode of the first dipole,
moving the two dipoles (D1, D2) closer together to a sufficiently reduced distance to create therebetween electrical and chemical interactions and thereby form an at least quadripolar electrolysis system,
channeling the gases resulting from the electrolysis implemented via a first dipole (D1) to the second dipole (D2).

2. Method according to claim 1, characterized in that it comprises the following operation:
channeling the gases resulting from the electrolysis implemented by a first dipole (D1) to the second dipole (D2) for the purposes of energy production, i.e. electrons, which are consumed in the other reactions.

3. Method according to claim 1, characterized in that it comprises the following operation:
channeling the gases resulting from the electrolysis implemented by a first dipole (D1) to the second dipole (D2) by directing the gases from the anode (A1) of the first dipole (D1) toward the cathode (C2) of the second dipole (D2) and the gases from the cathode (C1) of the first dipole (D1) toward the anode (A2) of the second dipole (D2).

4. Method according to claim 1, characterized in that it consists of producing hydrogen peroxide according to the following synthesis:
H₂(gas from the cathode of the first dipole)+O₂(gas present on the anode of the second dipole)→H₂O₂.

5. Method according to claim 1, characterized in that it consists of producing dichlorine according to the following reactions:
At the anode of the first dipole 2Cl⁻→Cl₂+2e⁻
At the anode of the second dipole 2Cl⁻→Cl₂+2e⁻ and H₂→2H⁺+2e⁻.

6. Method according to claim 2, characterized in that at least one operation is selected from the following list:
increasing the exchange contact surface area at one or a plurality of electrodes,
locking the current intensity for the second dipole (D2),
selecting a catalyst material for the anode (A2) of the second dipole (D2).

7. Method according to claim 1, characterized in that it further comprises the following operation:
producing carbon dioxide (CO₂) by producing an anode (A1) made of carbon or graphite for the first dipole (D1).

8. Method according to claim 1, characterized in that it comprises the following operation:
producing carbon dioxide (CO₂) by injecting an electrolyte based on bicarbonate into the water to be treated.

9. Method according to claim 1, characterized in that it comprises the following operation:
producing persulfate, the anode producing dioxygen (O₂) of the first dipole producing the following oxidation reaction:
2SO₄²⁻→S₂O₈²⁻(peroxodisulfate).

10. Method according to claim 9, characterized in that it comprises the following operation:
producing persulfate from the sulfate ions naturally present in the water to be treated.

11. Method according to claim 9, characterized in that it comprises the following operation:
producing persulfate from the sulfate ions present in an electrolyte injected into the water to be treated.

12. Method according to claim 1, characterized in that it comprises the following operation:
applying a different voltage according to the dipoles (D1, D2) so as to promote interactions between the electrodes of different dipoles so as to create new dipoles.

13. Method according to claim 4, characterized in that it comprises the following operation:
arranging a porous lining (600) downstream from the second dipole (D2) so as to promote the synthesis of hydrogen peroxide.

14. Method according to claim 1, characterized in that it comprises the following operation:
circulating one or a plurality of electrolytes in the enclosure (330).

15. Method according to claim 1, characterized in that it comprises the following operation:
varying the flow rate in order to establish the correct residence time of the electrolyte in the enclosure (330).

16. Method according to claim 1, characterized in that the connections of each dipole (D1, D2) are independent.

17. Device (D) for implementing the method according to claim 1, characterized in that it comprises an enclosure (330) equipped with an inlet (310) and an outlet (320) of the water to be treated, said enclosure receiving at least four electrodes:
two anodes (A1, A2) and two cathodes (C1, C2),
with a single membrane (500) creating a separation between the anodes (A1, A2) and the cathodes (C1, C2), said membrane (500) creating a conduit directing the displacement of the gases produced by a first dipole (D1) toward a second dipole (D2) while allowing ion migration.

18. Device (D) according to claim 17, characterized in that a first dipole (D1) is arranged below a second (D2).

19. Device according to claim 18, characterized in that said membrane (500) forms a tube separating:
the anode (A1) from the cathode (C1) of a first dipole (D1) with the anode (A1) arranged in the hollow core of the tube (500) and,
the anode (A2) from the cathode (C2) of the second dipole (D2) with the cathode (C2) arranged in the hollow core of the tube (500).

20. Device (D) according to claim 17, characterized in that it comprises a trapped gas exhaust orifice (700).

21. Device (D) according to claim 17, characterized in that it comprises a porous lining (600) positioned downstream from the second dipole (D2).

22. Device (D) according to claim 17, characterized in that it comprises a pump (210) for regulating the water flow rate in the enclosure (330).

23. Device (D) according to claim 17, characterized in that it comprises an electrolyte and/or reagent tank (400) and an injection module (220) arranged upstream from the enclosure (330) and communicating with the inlet (310) of the enclosure (330).

24. Device (D) according to claim 17, characterized in that the anode (A1) and the cathode (C2) arranged in the hollow core of the tubular membrane (500) are one-piece rectilinear rods whereas the anode (A2) and the cathode (C1) arranged outside the membrane (500) are windings.

25. Device (D) according to claim 17, characterized in that said membrane (500) is an ion exchange member and impermeable to water.

26. Device (D) according to claim 17, characterized in that the four electrodes forming a pair of dipoles are rigidly connected to the same cap to form an interchangeable independent module secured to the enclosure by closing the orifices provided for this purpose, said enclosure comprising a plurality of orifices suitable for optionally each receiving a module.
